(19) United States
(12) Patent Application Publication
(10) Pub. No.: US 2003/0003184 A1
(43) Pub. Date: Jan. 2, 2003

(54) Machine for manufacturing a capital for an architectural column

(76) Inventor: Barney J. Auman, Logan, UT (US)

Correspondence Address: FEHR LAW FIRM, Suite 300, Goldenwest Corporate Center, 5025 Adams Avenue, Ogden, UT, 84403, US

(21) Appl. No.: 09/895,611

(22) Filed: Jun. 29, 2001

(51) Int. Cl. B28B 21/22

(52) U.S. Cl. 425/435

(57) ABSTRACT

A machine for manufacturing a capital for an architectural column. The machine has a shaft with a releasable connector for attaching a mold for an architectural column to the shaft. Traditional means are employed to produce rotation of the shaft. Rotation of the shaft occurs in multiple axes, preferably two substantially orthogonal axes. These are preferably the pitch and roll axes. Rotation in more than two axes is, however, also contemplated. Also preferably, the shaft extends substantially symmetrically about the point of rotation for the first axis.

### BACKGROUND OF THE INVENTION

1. Field of the Invention

This invention relates to a machine used to rotate the mold of a capital for an architectural column in the process of manufacturing a capital from elastomers and foams or elastomer-foam combinations. As used throughout this document, the term “elastomer” is meant also to include a “resin”; and the term “foam” includes any liquid that will expand and create a lightweight filler.

2. Description of the Related Art

The inventor is unaware of any patents relating to a machine used for rotating molds for architectural structures to produce elastomer or elastomer-foam products.

Traditionally, due to the difficulty in working with elastomers or both elastomers and foam, capitals for architectural columns have not been manufactured from these materials. The process for making such capitals preferably involves rotation, as described in copending U.S. patent application Ser. No. 09/862,893, filed on May 22, 2001. And it is further preferable to accomplish such rotation with a machine.

It is assumed by the inventor that a machine to aid in the process of making capitals for architectural columns from elastomers or both elastomers and foam, has not been constructed due to the difficulty presented in finding and/or utilizing a process by which capitals could be produced using these materials, with or without the machine, resulting in a desirable outcome.

### SUMMARY OF THE INVENTION

In the process of making architectural capitals from elastomers and elastomer/foam combinations it is preferred that the mold of the capital be rotated about multiple, preferably two, axes to assure that the elastomers cover the entire inside surface of the mold.

Rotation of the mold can be accomplished in any manner but due to the difficulty of rotating the mold by hand it is preferably done by machine.

The Machine of the present invention has a shaft that is rotated about multiple axes, preferably substantially orthogonal axes, and most preferably the roll axis and also the yaw axis.

The shaft is removably attached to the mold of the capital.

Preferably, the shaft extends symmetrically about the point of rotation, or fulcrum for rotation, for the first, preferably the pitch, axis. This permits a mold to be attached at each end of the shaft and thereby balances the load on the shaft.

### BRIEF DESCRIPTION OF THE DRAWINGS

FIG. 1 depicts a typical setup which allows the capital mold to be attached to the Machine.

FIG. 2 depicts one possible machine design that will rotate a mold upon two axes to aid in the process of making capitals from elastomers or both elastomers and foam.

FIG. 3 depicts the same Machine design as that of FIG. 2, but from a different viewpoint.

FIG. 4 depicts another possible Machine design that will rotate a mold upon two axes to aid in the process of making capitals from elastomers or both elastomers and foam.

FIG. 5 depicts the same Machine design as that of FIG. 4, but from a different viewpoint.

FIG. 6 depicts yet another possible Machine design that will rotate a mold upon two axes to aid in the process of making capitals from elastomers or both elastomers and foam.

FIG. 7 depicts the same Machine design as that of FIG. 6, but from a different viewpoint.

### DESCRIPTION OF THE PREFERRED EMBODIMENT

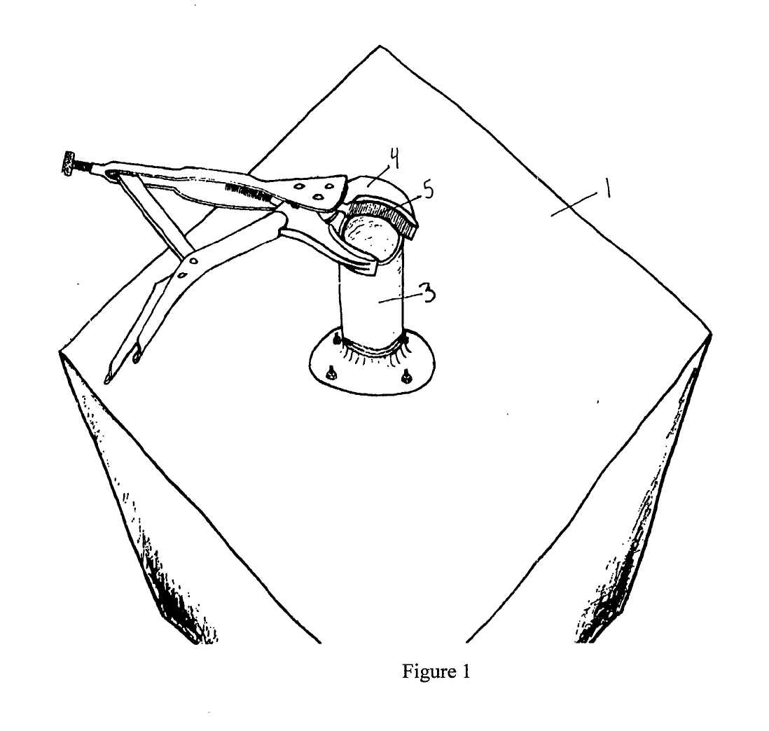

To a capital mold 1 is attached a first portion of a connector, preferably a pipe attachment, 3 for releasably connecting the mold to a shaft 2 of a Machine. Attachment of the pipe attachment 3 can be by any means that is well known in the art, such as, but not necessarily limited to, screws or bolts and nuts, as depicted in FIG. 1.

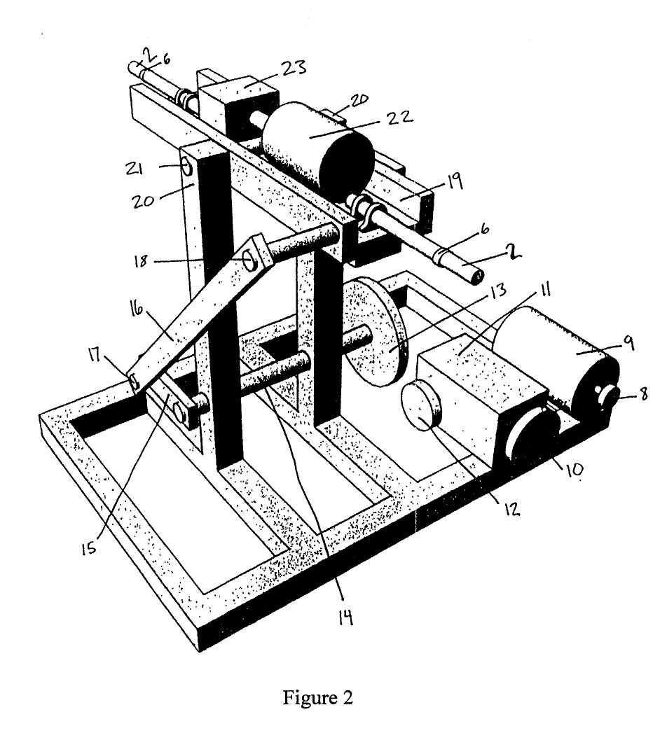

The capital mold 1 is preferably, but not necessarily, placed upon the shaft 2 of the Machine (FIGS. 2-7) by inserting the shaft 2 into the pipe attachment 3 upon the capital mold 1. The shaft 2 is inserted until vice grips 4, of which one jaw 5 has been welded to the pipe attachment 3, slide past the slip ring 6. The vice grips 4 are then tightened onto the shaft 2.

The strength of the vice grips 4 alone, clamped onto the shaft 2, is sufficient to keep the capital mold 1 upon the machine (FIGS. 2-7) during operation, and therefore the slip rings 6 are not fully necessary. However, due to safety precautions, these slip rings 6 are used so that if there is any slippage of the vice grips 4 upon the shaft 2 during operation of the machine (FIGS. 2-7), the vice grips 4 will not be able to slide further down the shaft 2 than the position of the slip rings 6. This prevents the mold 1 from being dropped. The pipe attachment 3 is, thus, preferably of such a dimension that the outside diameter of the slip rings 6 is less than the inside diameter of the pipe attachment 3.

The preceding is merely one example of a releasable connector for attaching the mold 1 to the shaft 2. Of course, any releasable connector that is known in the art could be utilized.

In order to put less stress upon the machine (FIGS. 2-7) and its components, it is preferred that the shaft extend substantially symmetrically about the point for which rotation will occur for the pitch axis, i.e., the fulcrum about which rotation will occur in the pitch axis, so that a mold 1 can be attached near both ends of the shaft and that the weight upon both ends of the shaft 2 will be approximately balanced (It is preferred but not necessary that molds 1 of approximately equal weight are placed upon both shafts 2 and that the capitals for these respective molds 1 are made during the same period of time. If this is not desired, another plausible solution would be to attach weights, whose sum is approximately equal to the weight of the mold 1, on the shaft 2 opposite that of the mold 1.).

Once the mold(s) 1 and/or weights are securely attached to the Machine (FIGS. 2-7) upon the shafts 2 the Machine (FIGS. 2-7) is then started. The rotation of the capital mold 1 upon the machine (FIGS. 2-7) is provided by any number of possible arrangements of machinery which may be composed of, but not limited to: motors, belts, chains, levers, gears, transmissions, and differentials. FIGS. 2-7 show three examples different Machine designs that can be used. The critical feature is that the Machine rotate the mold 1 about multiple axes, preferably two and preferably substantially orthogonal axes.

A description of the components and the functions of these components for the three exemplary Machines, which produce the desired result (i.e., rotation of the mold 1 upon two axes), follows. In each of the drawings for these examples the belts and/or chains (whichever is preferred) which attach one pulley to another have not been drawn in order to allow a clear view of the other components of each machine. It will be assumed that they are there and do exist, though not drawn, for it is by these belts and/or chains which energy is transferred from one point to another in the machine system.

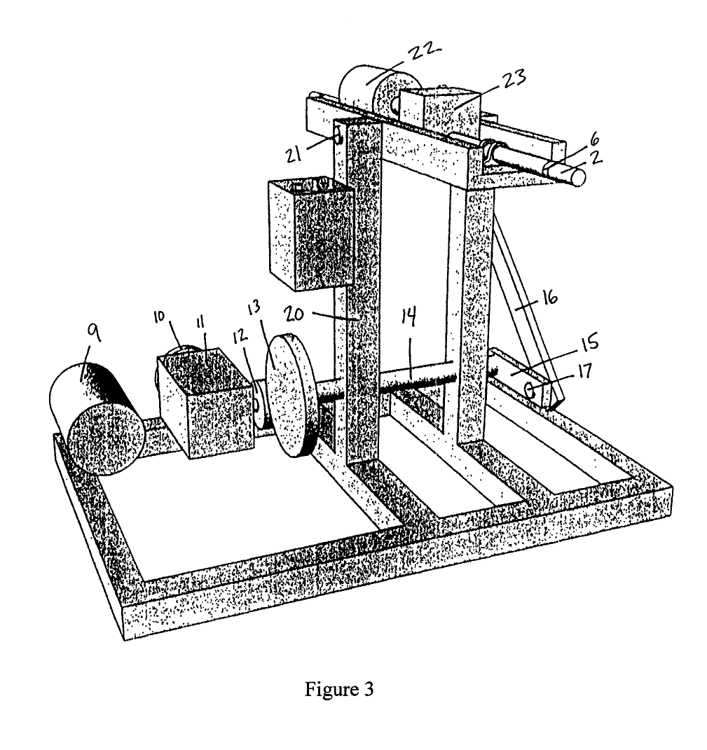

FIG. 2 and FIG. 3 show the same Machine 7 at different angles, this Machine 7 being one of the possibilities to achieve rotation upon two axes. In this Machine 7 the pulley 8 of a motor 9 is used to turn the pulley 10 of a differential 11 which in turn rotates another pulley 12 of that differential 11. That pulley 12 of the differential 11 then rotates a different pulley 13 which is attached and fixed rigidly to a bar 14. This bar 14 then rotates precisely with the rotation of this pulley 13. Upon another part of the bar 14 is also rigidly fixed a lever arm 15. As the bar 14 rotates, the lever arm 15 rotates precisely with it. At another point upon this lever arm 15 is freely attached second lever arm 16 allowing the second lever arm 16 to rotate freely about a pin 17 which attaches it to the first lever arm 15, and upon a plane parallel to the first lever arm 15. At another place on this second lever arm 16 is freely attached a second pin 18 which is rigidly attached to a table 19. This table 19 is supported by two bars 20. Through these bars 20, and through the center of the table 19, passes a third pin 21, allowing the table 19 to freely rotate about this pin 21. Hence as the pulley 13 attached to the bar 14 is rotated, and in turn rotates both the first lever 15 arm and the second lever arm 16, the table 19 is rotated, or pivoted, about the third pin 21. This is due to the second pin 18 which attaches the second lever arm 16 to the table 19. This angular motion, the table 19 pivoting about the third pin 21, gives the mold 1 attached to the shaft 2 rotation about the pitch axis. To obtain rotation about a second axis a second motor 22 is placed upon the table 19 which rotates the bar ends 2 orthogonally to the pivoting motion of the table 19 about the third pin 21, i.e., about the roll axis. The angular velocity of the rotation of the ends of the shaft 2 is controlled and can be changed by a transmission 23 mounted also upon the table 19. The angular velocity of the rotation of the table 19 about the third pin 21 is controlled by the speed of the first motor 9. This is desirable since adjustments of the velocities of rotation about the axis is preferred.

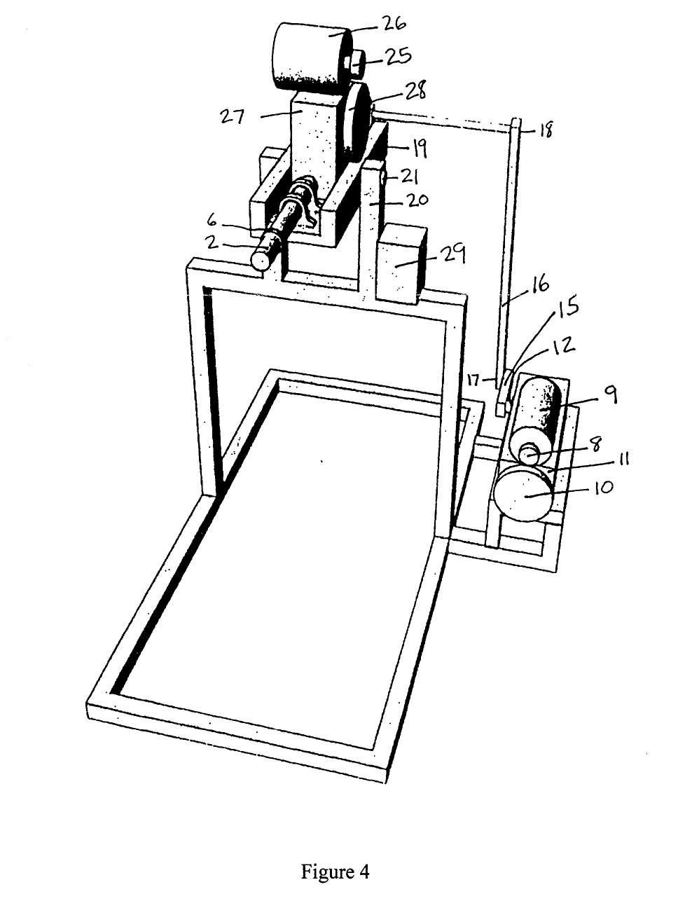

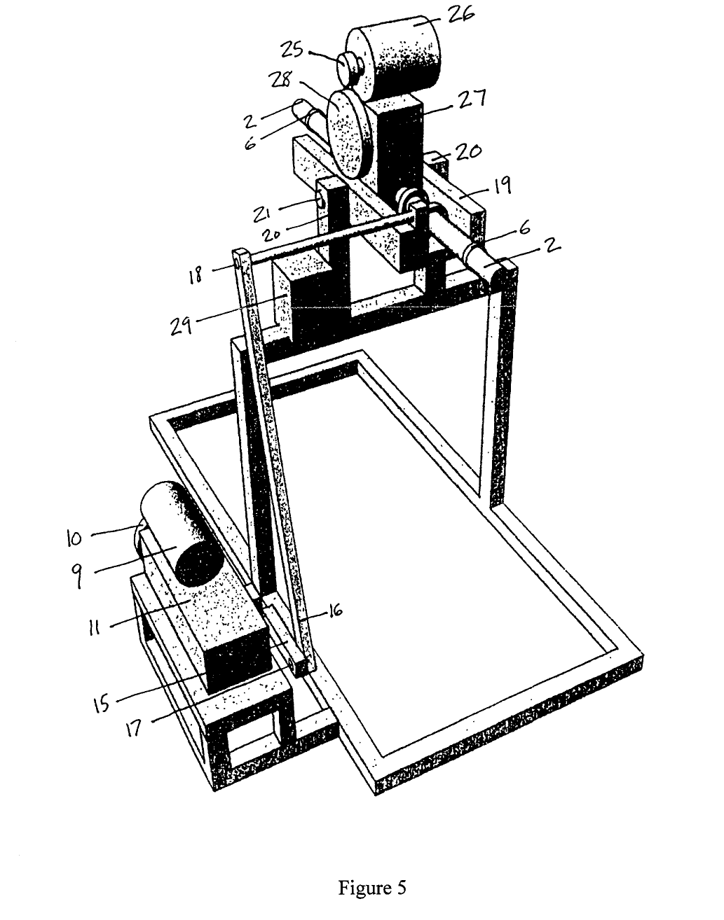

In FIG. 4 and FIG. 5 a second Machine 24 design possibility is presented. Here, the pulley 8 of a motor 9 turns the pulley 10 of a differential 11 which in turn rotates another pulley 12 of the differential 11. The rotation of the second pulley 12 of the differential 11 rotates a lever arm 15. This lever arm 15 in turn rotates a second lever arm 16 as it is freely attached to that second lever arm 16 by a pin 17 (as previously described with the first machine 7 design possibility above). As it is attached to a table 19 by a second pin 18 (as previously described with the first machine 7 design possibility above) the movement of the second lever arm 16 causes the table 19 to pivot about a third pin 21. This third pin 21 passes through both two supporting bars 20 and the table 19 (as previously described with the first machine 7 design possibility above). This allows for rotation about the pitch axis. For the rotation about a second axis, the pulley 25 of a second motor 26, which can, but not necessarily is, fixed on top of a differential 27 which is fixed to the table 19, turns the pulley 28 of the differential 27. The differential 27 then rotates the shaft 2 upon which are the molds 1 in the roll axis. The velocities of the rotations about the different axes are controlled by the speed of the first motor 9 and the second motor 26, respectively. The speeds of the first motor 9 and the second motor 26 can be controlled by a control box 29.

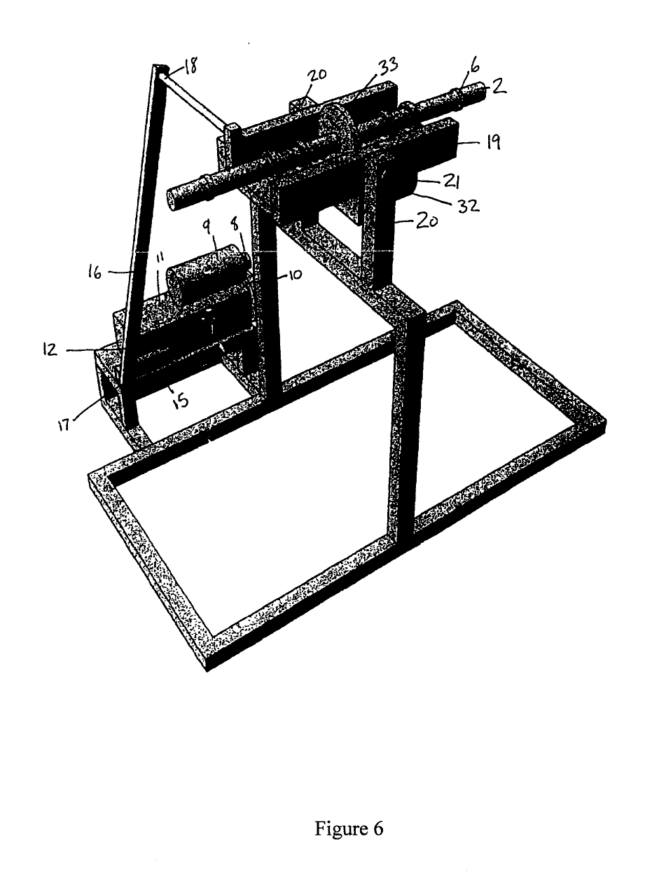

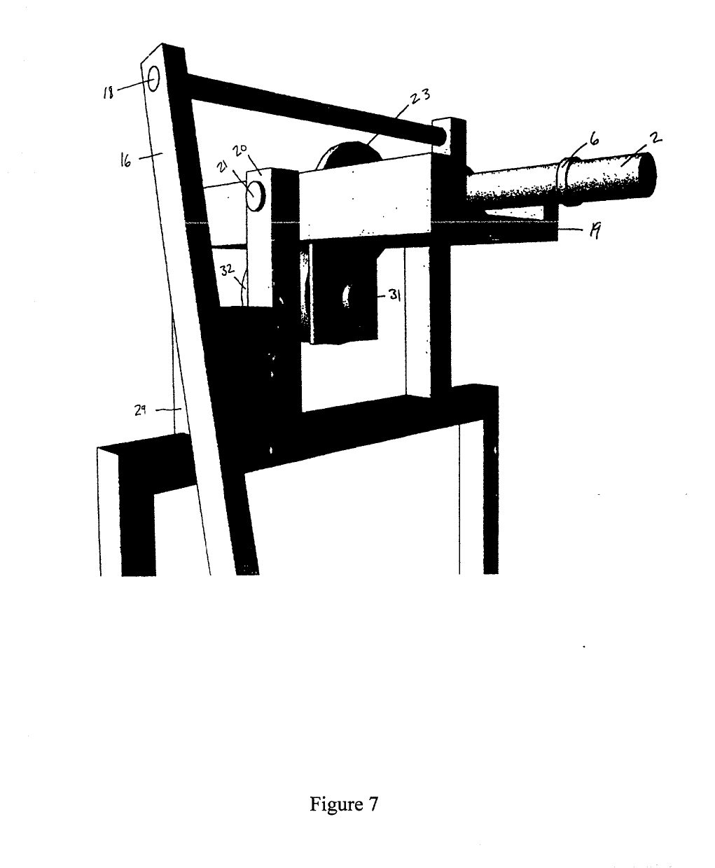

FIG. 6 and FIG. 7 represent yet a third possibility of a machine 30 used to rotate the capital molds 1 about two axes. In these figures the pulley 8 of a motor 9 turns the pulley 10 of a differential 11 which in turn rotates another pulley 12 of the differential 11. The rotation of the second pulley 12 of the differential 11 rotates a lever arm 15. This lever arm 15 in turn rotates a second lever arm 16 since it is freely attached to that second lever arm 16 by a pin 17 (as previously described with the first machine 7 design possibility above). Since it is attached to a table 19 by a second pin 18 (as previously described with the first machine 7 design possibility above), the movement of the second lever arm 16 causes the table 19 to pivot about a third pin 21. This third pin 21 passes through both two supporting bars 20 and the table 19 (as previously described with the first machine 7 design possibility above). This allows for rotation about the pitch axis. For rotation about a second axis the pulley 31 of a second motor 32 mounted preferably, but not necessarily, to the underneath of the table 19 rotates a pulley 33 through which passes the shaft 2. The rotation of this pulley 33 rotates the shaft 2 in the roll axis. The velocities of the rotations about the different axes are controlled by the speed of the first motor 9 and the second motor 32, respectively. The speeds of the first motor 9 and the second motor 32 can be controlled by a control box 29.

Rotation about a third substantially orthogonal (to both the first axis and the second axis) axis, the yaw axis in the preceding examples, could be accomplish simply by attaching a motor that provides rotary motion to the supporting bars 20.

The pitch, roll, and yaw axes are used herein to denote the same axes are they signify in the case of airplanes.

I claim:

1. A machine for manufacturing a capital for an architectural column, which comprises:
a shaft;
a means for rotating said shaft about a first axis;
a means for rotating said shaft about a second axis that is substantially orthogonal to said first axis; and
a releasable connector attached to said shaft for connecting a mold to said shaft.

2. The machine for manufacturing a capital for an architectural column as recited in claim 1, wherein:
said shaft extends substantially symmetrically about the point of rotation for the first axis.

3. The machine for manufacturing a capital for an architectural column as recited in claim 2, further comprising:
a means for rotating said shaft about a third axis that is substantially orthogonal both to the first axis and to the second axis.

4. The machine for manufacturing a capital for an architectural column as recited in claim 3, wherein:
the first axis is the pitch axis, the second axis is the roll axis, and the third axis is the yaw axis.

5. The machine for manufacturing a capital for an architectural column as recited in claim 2, wherein:
the first axis is the pitch axis, and the second axis is the roll axis.

6. The machine for manufacturing a capital for an architectural column as recited in claim 1, further comprising:
a means for rotating said shaft about a third axis that is substantially orthogonal both to the first axis and to the second axis.

7. The machine for manufacturing a capital for an architectural column as recited in claim 6, wherein:
the first axis is the pitch axis, the second axis is the roll axis, and the third axis is the yaw axis.

8. The machine for manufacturing a capital for an architectural column as recited in claim 1, wherein:
the first axis is the pitch axis, and the second axis is the roll axis.
